(19) United States
(12) Patent Application Publication
(10) Pub. No.: US 2019/0138398 A1
(43) Pub. Date: May 9, 2019

(54) ENHANCING DATA BACKUP AND RECOVERY PERFORMANCE

(71) Applicant: EMC IP Holding Company LLC, Hopkinton, MA (US)

(72) Inventors: Tushar Dethe, Bangalore (IN); Sunil Yadav, Bangalore (IN); Shelesh Chopra, Bangalore (IN); Amarendra Behera, Bangalore (IN); Anushri Verma, Bangalore (IN)

(21) Appl. No.: 15/802,606

(22) Filed: Nov. 3, 2017

(51) Int. Cl. G06F 11/14; G06F 3/06; G06F 17/30

(52) U.S. Cl. CPC G06F 11/1464; G06F 11/1448; G06F 2201/84; G06F 17/30088; G06F 3/067

(57) ABSTRACT

Systems, methods, and computer-readable media can present improved data backup of data servers, including Microsoft Exchange servers. Embodiments can provide backup of a data server using a backup application, where the backup application can send a request to the data server for data to backup and receive a first set of backup data from the data server. The backup application can also send a request to the data server for backup data criteria and receive backup data criteria from the data server. The backup application may apply the backup data criteria to the first set of data to create a second set of backup data that is new, non-duplicated data sending the second set of backup data to a storage device, thus saving storage space, backup time, and network bandwidth.

### BACKGROUND

The present disclosure relates to optimally collecting, backing up, and recovering data from a data server such as a Microsoft Exchange® Server.

Backup software may rely on receiving accurate information on files that need to be backed up. In certain environments when a backup application queries a server or interface to a server for backup files, the application is asked to backup all files and data present on the server or a set of files, which may include files or data that is duplicated, or data that present in different files in the same server, otherwise previously stored and thus its repeated identical storage may not be necessary. This can lead to additional computational and storage overhead in terms of time and storage space.

There is a need, therefore, for an improved method, article of manufacture, and apparatus for server data collection, backup, and recovery.

### BRIEF SUMMARY

Embodiments can improve data storage processes using a backup application to facilitate more optimal data storage of data from a data server by not sending data that is present in different files by querying for information on only new sets of data to be stored.

Other embodiments are directed to systems, portable consumer devices, and computer readable media associated with methods described herein.

A better understanding of the nature and advantages of embodiments may be gained with reference to this detailed description and the accompanying drawings.

### BRIEF DESCRIPTION OF THE DRAWINGS

The present invention will be readily understood by the following detailed description in conjunction with the accompanying drawings, wherein like reference numerals designate like structural elements, and in which:

FIG. 1 illustrates a block diagram of an architecture for backup a data server in accordance with some embodiments of the present disclosure.

FIG. 2 is a flowchart of a method for backup of a data server in accordance with some embodiments of the present disclosure.

FIG. 3 is a block diagram of an example computer system 300 usable with system and methods according to various embodiments.

### DETAILED DESCRIPTION

A detailed description of one or more embodiments of the invention is provided below along with accompanying figures that illustrate the principles of the invention. While the invention is described in conjunction with such embodiment(s), it should be understood that the invention is not limited to any one embodiment. On the contrary, the scope of the invention is limited only by the claims and the invention encompasses numerous alternatives, modifications, and equivalents. For the purpose of example, numerous specific details are set forth in the following description in order to provide a thorough understanding of the present invention. These details are provided for the purpose of example, and the present invention may be practiced according to the claims without some or all of these specific details. For the purpose of clarity, technical material that is known in the technical fields related to the invention has not been described in detail so that the present invention is not unnecessarily obscured.

It should be appreciated that the present invention can be implemented in numerous ways, including as a process, an apparatus, a system, a device, a method, or a computer readable medium such as a computer readable storage medium or a computer network wherein computer program instructions are sent over optical or electronic communication links. Applications may take the form of software executing on a general purpose computer or be hardwired or hard coded in hardware. In this specification, these implementations, or any other form that the invention may take, may be referred to as techniques. In general, the order of the steps of disclosed processes may be altered within the scope of the invention.

An embodiment of the invention will be described with reference to a Microsoft Exchange® Server, but it should be understood that the principles of the invention are not limited to this configuration. The solutions to these problems provided by some embodiments may be applied to multiple different types of data server systems, and certain examples in this application use a Microsoft Exchange® Server program (hereinafter referred to as “Exchange” or “Exchange Server”) in particular as an example for the purposes of illustration and description. It is not intended to be exhaustive or to limit embodiments to the precise form described, an embodiment can be applied to other systems.

The present disclosure discusses systems, methods and processes for optimally collecting, backing up, and recovering data from a data server such as a Microsoft Exchange® Server.

Conventional Exchange backups for a database with large number of log files can take very long time to complete. When redundant data that is be present in other files is sent to be backed up again, there can be a significant slowdown in backup and restore operations. This can affect both full backups and incremental backups, restored in a variety of ways, for example whether granular or stored in a specific restore database (RDB). An RDB is a special kind of mailbox database that allows mounting and extraction of data from a restored mailbox database as part of a recovery operation. A granular restore, can restore the last possible single item from a mailbox. This can be for example an email, calendar request, task, or similar. The improved approaches discussed herein for backup can result in reduction in backup time, reduction in storage space, and reduction in restoration time. For example if the backup size is reduced, restore time may also be reduced.

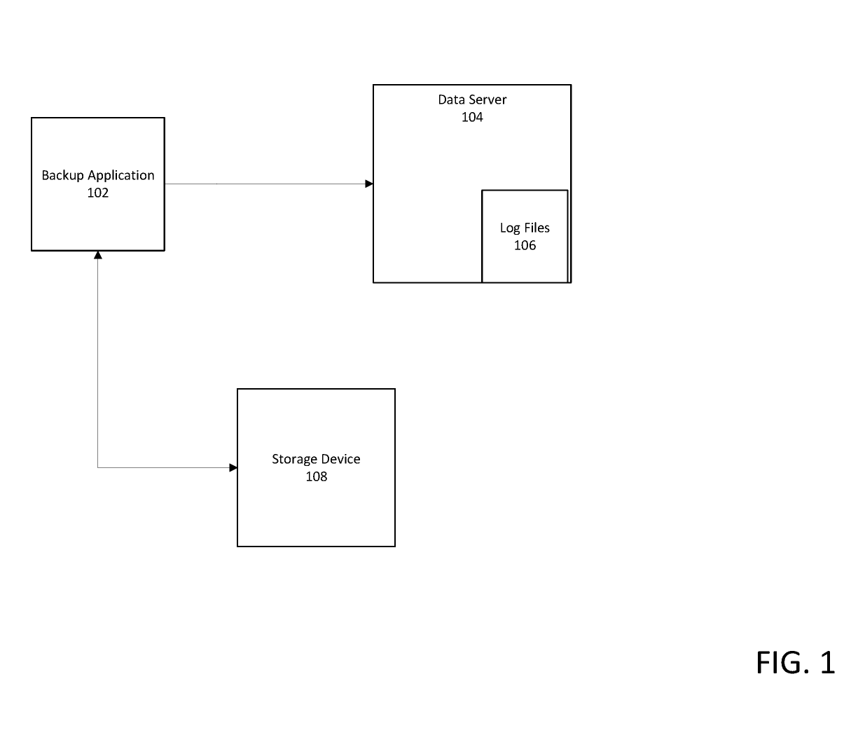

FIG. 1 depicts a backup system consistent with an embodiment of the present disclosure. In the example shown, backup application 102 communicates with data server 104 to more efficiently collect backup data from data server 104 and send it to data server 108. Backup application 102 may contain log files 106, which contain data to be backed up. Backup application 102 may send data to data server 108 for storage. Storage device may be any of a variety of storage devices, for example a Data Domain® storage device from Dell EMC.

Data server 104 may be a server such as an Exchange server, containing data such as electronic mail, calendaring, and collaboration data. Backup application 102 may be a standalone application or it may be an application integrated with another program on the data server. For example, if data server 104 is an Exchange server, backup application 102 may be a plugin to the Exchange program running on data server 104. Alternatively, it may be a standalone program running on data server 104 or on another device. For example, backup application 104 may be an Avamar® Exchange plugin.

Data server 104 may also contain log files 106, which contain data to be stored and other associated data. The data server 104 may also store data in other formats including, but not limited to in a database or in memory. For example in an Exchange server, there are at least three places that data can exist: memory, database files (*.edb) and transaction logs (*.log). In Microsoft Exchange, a transaction log is a file that contains a record of the changes that were made to an Exchange database. Information that needs to be added to a mailbox database may be first written to an Exchange transaction log and then the contents of that transaction log is later written to an Exchange Server database.

Backup application 102 can query data server 104 for data to be backed up, but the response from data server 104 may be inaccurate, often telling backup application to store information which has already been stored in different files of data server 108. Repeatedly storing data which has already been previously stored at a storage can incur significant performance penalties, including but not limited to: wasted storage space, increased memory usage, increased search time for relevant data, increased data transfer time and space, and increased energy consumption.

For example, conventional Microsoft Exchange backups for a large database with large number of log files can take very long time to complete. Backup software can use Volume Shadow Copy Service (VSS) technology to perform backup of Microsoft Exchange environment. Backup software (Requestor) can ask the writer (Microsoft Exchange writer) to provide information on what files (Backup Components) needs to be backed up. When an Exchange writer is queried for backup of a particular database, it returns the name of database and log files. In the case of log files, the writer may only report a folder name and specify backup component as *, meaning backup all the log files present in the folder.

The number of transactional logs can be directly proportional to number of mailboxes and activity in these mailboxes. In an enterprise environment with a large number of mailboxes, the number of log files at any point of time can also be very high. Research on these log files shows that not all log files present may necessarily be relevant. Often, the data present in these log files was already committed to the database.

In Exchange, for example, an exchange writer would ask a backup application to save the same information two or more times. This can result in wasted backup time and storage space. The present method may find the relevant log files and backup only these relevant log files, thus saving on backup time and storage space.

Microsoft Exchange, for example, provides a tool “eseutil.exe”, which is installed during the installation of Microsoft Exchange server. This tool can provide information on the range of logs (minimum.log to maximum.log) that have not been committed to a database file. The system may then check for the log files present in a log directory. From these log files the system may backup only the log files specified by the tool eseutil.exe. i.e. [“minimum.log” to “maximum.log”].

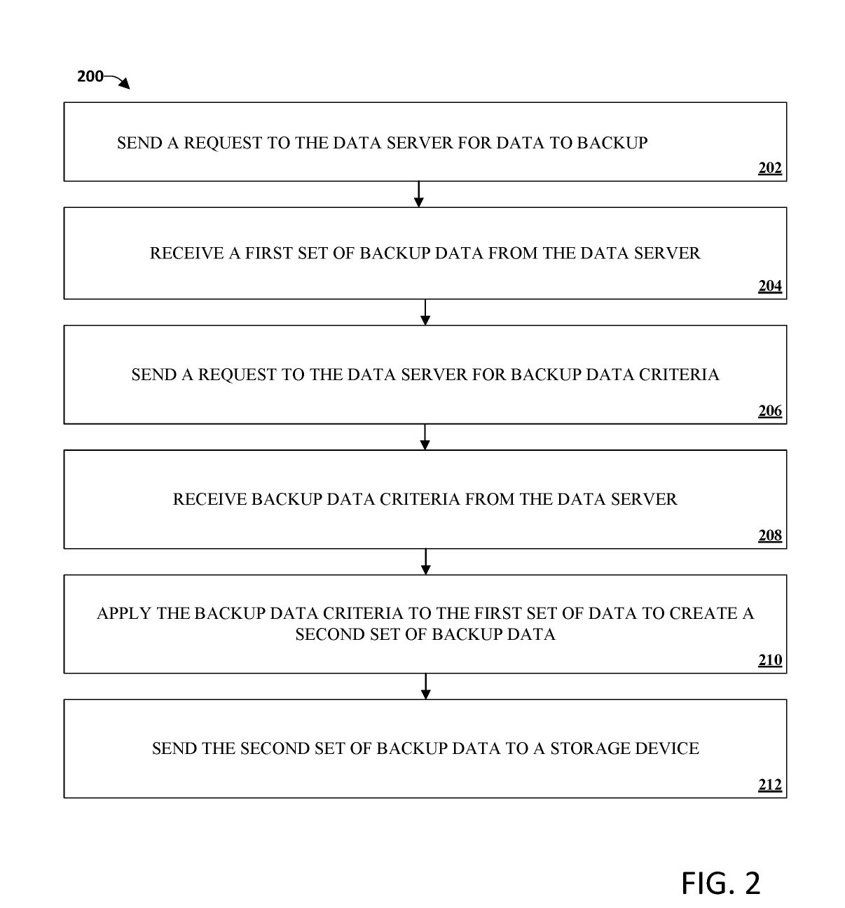

FIG. 2 is a flowchart of a method 200 for backup of a data server in accordance with some embodiments of the present disclosure. Method 200 may be implemented by elements of backup application 102 in communication with data server 104, and storing resultant data on data server 108. The method may occur on one or more devices, and the backup application may be a standalone application or it may be an application integrated with another program on the data server.

At block 202, a backup operation starts on the backup application. The backup application sends a request to the data server for data to backup. For example, the backup application may be an Avamar® Exchange Plugin, which asks an Exchange writer to provide the necessary files to be backed up.

The backup application may also ask to make a copy of the currently running database; i.e. take a snapshot of the database to create a snapshot database. For example, the backup application may ask the VSS framework to start with a snapshot operation on the data contained in the data server. Once Snapshot operation is done, the backup application can identify the snapshot location and mount the snapshot.

At block 204, a first set of backup data is received by the backup application from the data server. This can be live data from the data server, or from the mounted snapshot.

At block 206, a request is sent from the backup application to the data server for backup data criteria. This backup data criteria can consist of information to further refine the data that is to be backed up.

For example, on an Exchange server, a backup application can use eseutil.exe to provide backup criteria. If for example, the backup application is an Exchange plugin, the plugin may identify the location where the Exchange server is installed and may identify the location of eseutil.exe. The backup application may then use this location of eseutil.exe and execute a command on exeutil.exe. If using a snapshot database, the mounted snapshot database location may be passed. The backup application can then parse the output provided by eseutil.exe for field “Log Required” to identify the minimum number of log file (minimum.log) and maximum number of log file (maximum.log) that is required by the database.

At block 208, the backup application receives this backup data criteria, which can contain information that can be used to refine the data from the data server that is to be backed up.

At block 210, the backup data criteria is applied to the first set of data to create a second set of backup data. This application of the backup data criteria can reduce the amount of data to be backed up, making the backup process more efficient.

For example, the backup application can parse the log file location provided by the Microsoft Exchange writer to create a list of log files present in this folder. It may also sort this list in ascending order. The backup application can iterate through this list and include only those log files that are included in the range provided by the tool. For example, minimum.log to maximum.log. After this is done, a second set of backup data is created.

At block 212, the second set of backup data is ready to be backed up. The second set of backup data is sent to a storage device.

The process may be run on a live or on a snapshot database. Often times it may be desirable to use a snapshot database as opposed to a live database. Running on a live database may produce errors. In such a case, a snapshot of a live database is taken, then commands are run to find the information on data that is not committed to a database.

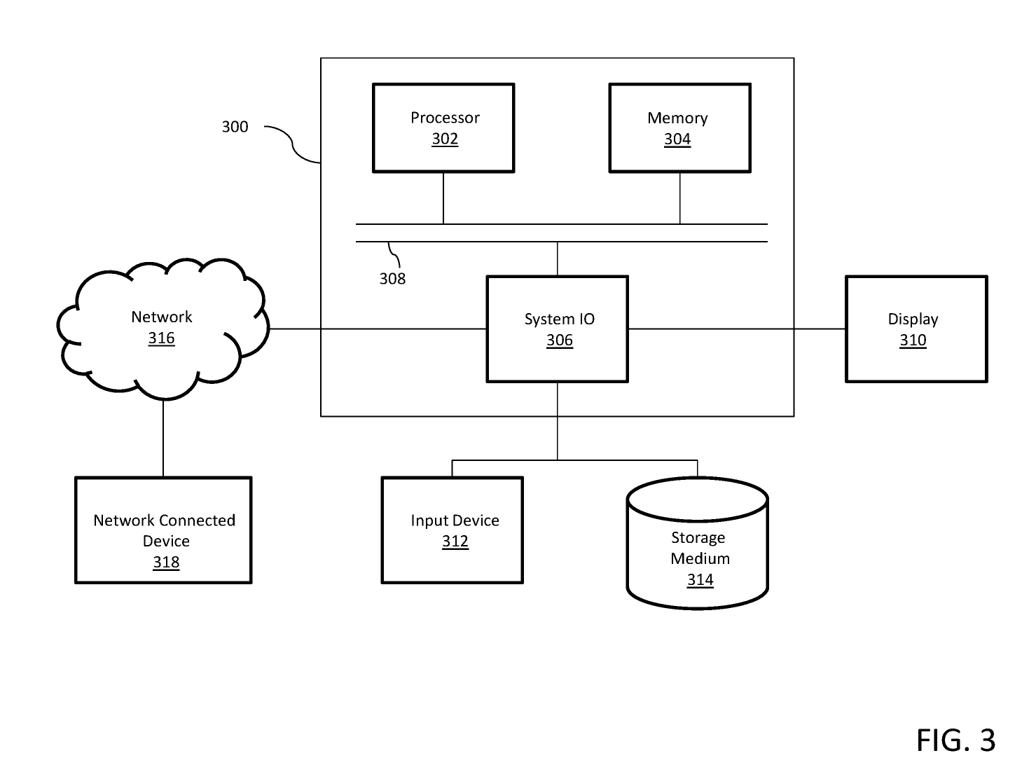

FIG. 3 depicts a computer system which may be used to implement different embodiments discussed herein. General purpose computer 300 may include processor 302, memory 304, and system IO controller 306, all of which may be in communication over system bus 308. In an embodiment, processor 302 may be a central processing unit (“CPU”) or accelerated processing unit (“APU”). Some embodiments may comprise multiple processors, or a processor with multiple cores. Processor 302 and memory 304 may together execute a computer process, such as the processes described herein.

System IO controller 306 may be in communication with display 310, input device 312, non-transitory computer readable storage medium 314, and/or network 316. Display 310 may be any computer display, such as a monitor, a smart phone screen, or wearable electronics and/or it may be an input device such as a touch screen. Input device 312 may be a keyboard, mouse, track-pad, camera, microphone, or the like, and storage medium 314 may comprise a hard drive, flash drive, solid state drive, magnetic tape, magnetic disk, optical disk, or any other computer readable and/or writable medium.

Network 316 may be any computer network, such as a local area network (“LAN”), wide area network (“WAN”) such as the internet, a corporate intranet, a metropolitan area network (“MAN”), a storage area network (“SAN”), a cellular network, a personal area network (PAN), or any combination thereof. Further, network 316 may be either wired or wireless or any combination thereof, and may provide input to or receive output from IO controller 306. In an embodiment, network 316 may be in communication with one or more network connected devices 318, such as another general purpose computer, smart phone, PDA, storage device, tablet computer, or any other device capable of connecting to a network.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor.

All references cited herein are intended to be incorporated by reference. Although the present invention has been described above in terms of specific embodiments, it is anticipated that alterations and modifications to this invention will no doubt become apparent to those skilled in the art and may be practiced within the scope and equivalents of the appended claims. More than one computer may be used, such as by using multiple computers in a parallel or load-sharing arrangement or distributing tasks across multiple computers such that, as a whole, they perform the functions of the components identified herein; i.e. they take the place of a single computer. Various functions described above may be performed by a single process or groups of processes, on a single computer or distributed over several computers. Processes may invoke other processes to handle certain tasks. A single storage device may be used, or several may be used to take the place of a single storage device. The disclosed embodiments are illustrative and not restrictive, and the invention is not to be limited to the details given herein. There are many alternative ways of implementing the invention. It is therefore intended that the disclosure and following claims be interpreted as covering all such alterations and modifications as fall within the true spirit and scope of the invention.

1. A computer-implemented method for backup of a data server, the method comprising:
sending a request to the data server for data to backup;
receiving a first set of backup data from the data server, the first set of backup data comprising database and log file information;
sending a request to the data server for backup data criteria;
receiving backup data criteria from the data server, wherein the backup data criteria comprises log file ranges that refine the first set of backup data;
applying the backup data criteria to the first set of backup data to reduce the size of the first backup data to create a second set of backup data; and
sending the second set of backup data to a storage device.

2. The method of claim 1, wherein the data server takes a snapshot of data stored, and wherein the first set of data comprises data from the snapshot.

3. The method of claim 2, further comprising sending the data server a request to take the snapshot.

4. The method of claim 1, wherein the first set of backup data further comprises a set of log files.

5. The method of claim 4, further comprising sorting the set of log files by an identifier unique to each log file in the set of log files.

6. (canceled)

7. The method of claim 1, wherein the backup data criteria further comprises a minimum and a maximum value.

8. A computer program product for backup of a data server, comprising a non-transitory computer readable medium having a computer-readable program code embodied therein, the computer-readable program code adapted to be executed by one or more processors to implement a method comprising:
sending a request to the data server for data to backup;
receiving a first set of backup data from the data server, the first set of backup data comprising database and log file information;
sending a request to the data server for backup data criteria;
receiving backup data criteria from the data server, wherein the backup data criteria comprises log file ranges that refine the first set of backup data;
applying the backup data criteria to the first set of backup data to reduce the size of the first backup data to create a second set of backup data; and
sending the second set of backup data to a storage device.

9. The computer program product of claim 8, wherein the data server takes a snapshot of data stored, and wherein the first set of data comprises data from the snapshot.

10. The computer program product of claim 9, further comprising sending the data server a request to take the snapshot.

11. The computer program product of claim 8, wherein the first set of backup data further comprises a set of log files.

12. (canceled)

13. The computer program product of claim 8, wherein the backup data criteria further comprises a minimum and a maximum value.

14. A system for backup of a data server comprising a non-transitory computer readable medium and a processor configured to:
send a request to the data server for data to backup;
receive a first set of backup data from the data server, the first set of backup data comprising database and log file information;
send a request to the data server for backup data criteria;
receive backup data criteria from the data server, wherein the backup data criteria comprises log file ranges that refine the first set of backup data;
apply the backup data criteria to the first set of backup data to reduce the size of the first backup data to create a second set of backup data; and
send the second set of backup data to a storage device.

15. The system of claim 14, wherein the data server takes a snapshot of data stored, and wherein the first set of data comprises data from the snapshot.

16. The system of claim 15, further comprising sending the data server a request to take the snapshot.

17. The system of claim 14, wherein the first set of backup data further comprises a set of log files.

18. The system of claim 17, further comprising sorting the set of log files by an identifier unique to each log file in the set of log files.

19. (canceled)

20. The system of claim 14, wherein the backup data criteria further comprises a minimum and a maximum value.
